(19) United States
(12) Patent Application Publication
(10) Pub. No.: US 2022/0025483 A1
(43) Pub. Date: Jan. 27, 2022

(54) RECOVERING METAL OXIDES FORM A PAINT SLUDGE

(71) Applicants: Malek Naderi, Tehran (IR); Davoud Fatmehsari Haghshenas, Tehran (IR); Arash Ghazitabar, Tehran (IR)

(72) Inventors: Malek Naderi, Tehran (IR); Davoud Fatmehsari Haghshenas, Tehran (IR); Arash Ghazitabar, Tehran (IR)

(73) Assignee: Amirkabir University of Technology, Tehran (IR)

(21) Appl. No.: 17/396,672

(22) Filed: Aug. 7, 2021

Related U.S. Application Data
(60) Provisional application No. 63/083,871, filed on Sep. 26, 2020.

(51) Int. Cl. C22B 34/12; C22B 7/00; C22B 21/00

(52) U.S. Cl. CPC C22B 34/1245; C22B 21/0023; C22B 7/007; C22B 7/008

(57) ABSTRACT

A method for recovering metal oxides from a paint sludge. The method may include obtaining a first mixture by evaporating an organic part of the paint sludge. Evaporating the organic part of the paint sludge may include heating the paint sludge in a furnace. The method may further include precipitating a second mixture from the first mixture by mixing the first mixture and a sodium hydroxide solution. The method may further include recovering titanium dioxide from the second mixture by mixing the second mixture with a hydrochloric acid solution.

### CROSS-REFERENCE TO RELATED APPLICATION

This application claims the benefit of priority from pending U.S. Provisional Patent Application Ser. No. 63/083,871, filed on Sep. 26, 2020, and entitled “RECOVERY OF PRECIOUS MATERIALS FROM AUTOMOTIVE PAINT SLUDGE,” which is incorporated herein by reference in its entirety.

### TECHNICAL FIELD

The present disclosure relates to recovering metal oxides form a paint sludge and more particularly relates to recovering titanium dioxide from a paint sludge.

### BACKGROUND

Paint sludge is one of the hazardous wastes of automotive industry. Paint sludge may include organic and inorganic substances, such as heavy metals, fillers, metal flakes, and pigments. Heavy metals of a paint sludge may include lead, cadmium, nickel, mercury, and arsenic, which may jeopardize environmental health. A paint sludge may also include substances which tend to coalesce into a film and therefore such coalescing substances may make a paint sludge sticky and hard to handle.

Recovering a paint sludge may be environmentally and economically desirable due to the fact that a paint sludge may also contain useful minerals which can be reused as raw materials for paint industries. Various recovering methods may be applied to recover useful minerals of a paint sludge including organic and inorganic parts, such as pyrolysis, and using cationic flocculants. The most applicable strategy of recovering inorganic and organic parts may be pyrolysis, which may be performed by applying a high temperature in a range of 1000° C. to 1200° C. Flocculating a paint sludge may be time consuming and may require anionic dispersants. In another recovering method, potassium hydroxide may be used in pyrolysis processes. However, this method may not be appropriate for separating both inorganic and organic parts due to the formation of inorganic compounds.

There is, therefore, a need for a cost-effective and time-saving method to recover inorganic parts of a paint sludge. There is further a need for developing a method for recovering inorganic parts of a paint sludge with high purity.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a method for recovering metal oxides from a paint sludge. In an exemplary embodiment, an exemplary method may include obtaining a first mixture by evaporating an organic part of an exemplary paint sludge. In an exemplary embodiment, evaporating an exemplary organic part of an exemplary paint sludge may include heating an exemplary paint sludge in a furnace. In an exemplary embodiment, an exemplary method may further include precipitating a second mixture from an exemplary first mixture by mixing an exemplary first mixture and a sodium hydroxide solution. In an exemplary embodiment, an exemplary method may further include recovering titanium dioxide from an exemplary second mixture by mixing an exemplary second mixture with a hydrochloric acid solution.

In an exemplary embodiment, obtaining an exemplary first mixture may include heating an exemplary paint sludge under an inert atmosphere. In an exemplary embodiment, an exemplary inert atmosphere may include at least one of nitrogen and argon.

In an exemplary embodiment, precipitating an exemplary second mixture from an exemplary first mixture may include mixing an exemplary first mixture and an exemplary sodium hydroxide solution. In an exemplary embodiment, an exemplary sodium hydroxide solution may have a concentration in a range of 1 mol/L to 6 mol/L.

In an exemplary embodiment, precipitating an exemplary second mixture from an exemplary first mixture may include mixing an exemplary first mixture and an exemplary sodium hydroxide solution with a weight ratio in a range of 1:5 to 1:15 (first mixture:sodium hydroxide solution).

In an exemplary embodiment, precipitating an exemplary second mixture from an exemplary first mixture may include mixing an exemplary first mixture and an exemplary sodium hydroxide solution in a mechanical mixer with a stirrer speed in a range of 50 rpm to 400 rpm.

In an exemplary embodiment, precipitating an exemplary second mixture from an exemplary first mixture may include mixing an exemplary first mixture and an exemplary sodium hydroxide solution in an exemplary mechanical mixer for a period of 2 to 10 hours.

In an exemplary embodiment, precipitating an exemplary second mixture from an exemplary first mixture may include mixing an exemplary first mixture and an exemplary sodium hydroxide solution in an exemplary mechanical mixer at a temperature in a range of 25° C. to 90° C.

In an exemplary embodiment, recovering titanium dioxide from an exemplary second mixture may include mixing an exemplary second mixture with an exemplary hydrochloric acid solution with a weight ratio in a range of 1:5 to 1:15 (second mixture:hydrochloric acid solution).

In an exemplary embodiment, recovering titanium dioxide from an exemplary second mixture may include mixing an exemplary second mixture with an exemplary hydrochloric acid solution. In an exemplary embodiment, an exemplary hydrochloric acid solution may have a concentration in a range of 1 mol/L to 4 mol/L.

In an exemplary embodiment, recovering titanium dioxide from an exemplary second mixture may include mixing an exemplary second mixture with an exemplary hydrochloric acid solution in a mechanical mixer with a stirrer rate of 50 rpm to 400 rpm for 1 to 6 hours at 25° C. to 90° C.

In an exemplary embodiment, recovering titanium dioxide from an exemplary second mixture may further include heating titanium dioxide at a temperature in a range of 80° C. to 90° C. for 3 to 4 hours.

In an exemplary embodiment, precipitating an exemplary second mixture from an exemplary first mixture may further include filtering out an exemplary precipitated second mixture to obtain a supernatant solution.

In an exemplary embodiment, an exemplary method may further include precipitating aluminum hydroxide from an exemplary supernatant solution by injecting CO₂ into an exemplary supernatant solution. In an exemplary embodiment, an exemplary method may further include forming aluminum oxide by heating an exemplary precipitated aluminum hydroxide.

In an exemplary embodiment, precipitating aluminum hydroxide from an exemplary supernatant solution may include adjusting pH of an exemplary supernatant solution in a range of 7 to 12.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a flowchart of a method for separating metal oxides from a paint sludge, consistent with one or more exemplary embodiments of the present disclosure;

FIG. 2 illustrates thermogravimetric analysis (TGA) of a paint sludge, consistent with one or more exemplary embodiments of the present disclosure;

FIG. 3 illustrates X-ray diffraction (XRD) patterns of titanium, titanium dioxide, and a paint sludge before applying a heating process, consistent with one or more exemplary embodiments of the present disclosure;

FIG. 4 illustrates XRD patterns of iron, aluminum, titanium dioxide, and a paint sludge after applying a heating process, consistent with one or more exemplary embodiments of the present disclosure;

FIG. 5 illustrates X-ray fluorescence (XRF) data of a paint sludge, consistent with one or more exemplary embodiments of the present disclosure; and

FIG. 6 illustrates field emission scanning electron microscopy (FE-SEM) images of titanium dioxide after leaching processes, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is generally directed to exemplary embodiments of a method for separating titanium dioxide and aluminum oxide from a paint sludge. An exemplary method may include a pyrolysis step followed by a hydrometallurgical step. An exemplary pyrolysis step may include heating an exemplary paint sludge at a certain temperature to evaporate an organic part of an exemplary paint sludge. Heating an exemplary paint sludge may be carried out in a furnace under an inert atmosphere. When an exemplary organic part of an exemplary paint sludge is evaporated, the remaining mixture, which is referred to herein as the first mixture may include at least one of silicon dioxide, aluminum oxide, iron oxide, calcium oxide, titanium dioxide, magnesium oxide, sodium oxide, and potassium oxide.

An exemplary first mixture obtained from the pyrolysis step may then be taken out of an exemplary furnace and mixed with a sodium hydroxide solution. Mixing an exemplary first mixture and an exemplary sodium hydroxide solution may be carried out in a mechanical mixer. A sediment, referred to herein as second mixture, may form in an exemplary mechanical mixer in response to mixing of an exemplary first mixture and an exemplary sodium hydroxide solution. An exemplary second mixture may then be separated by filtration. An exemplary second mixture may include silicon dioxide, aluminum oxide, iron oxide, calcium oxide, titanium dioxide, magnesium oxide, sodium oxide, and potassium oxide.

An exemplary second mixture obtained from an exemplary hydrometallurgical process may then be mixed with a hydrochloric acid solution. Mixing an exemplary second mixture and an exemplary hydrochloric acid solution may be carried out in a mechanical mixer. Titanium dioxide may precipitate in an exemplary mechanical mixer in response to mixing an exemplary second mixture and an exemplary hydrochloric acid solution. An exemplary precipitated titanium dioxide may then be separated by filtration.

Precipitating an exemplary second mixture may further include filtering out an exemplary precipitated second mixture to obtain a supernatant solution. CO₂ may be injected into an exemplary supernatant solution to decrease the pH of an exemplary supernatant solution. Aluminum hydroxide may precipitate in response to a decrease in the pH. Aluminum hydroxide sediment may then be separated by filtration. In an exemplary embodiment, Aluminum hydroxide may be heated in a furnace to obtain aluminum oxide.

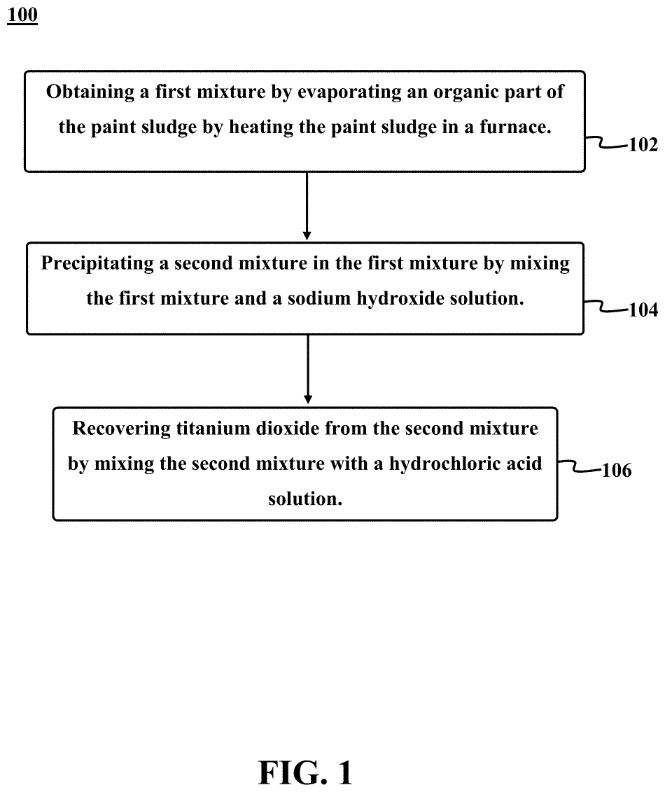

FIG. 1 illustrates a flowchart of a method 100 for separating metal oxides from a paint sludge, consistent with one or more exemplary embodiments of the present disclosure. In an exemplary embodiment, method 100 may include a step 102 of obtaining a first mixture by evaporating an organic part of the paint sludge by heating the paint sludge in a furnace, a step 104 of precipitating a second mixture in the first mixture by mixing the first mixture and a sodium hydroxide solution, and a step 106 of recovering titanium dioxide from the second mixture by mixing the second mixture with a hydrochloric acid solution.

In an exemplary embodiment, step 102 of obtaining the first mixture may include adding an exemplary paint sludge into a furnace, such as a pyrolysis furnace. An exemplary paint sludge may include an organic part and an inorganic part. To evaporate an exemplary organic part of an exemplary paint sludge, an exemplary paint sludge may be heated at a temperature in a range of 350° C. to 600° C. for 20 minutes to 2 hours. In an exemplary embodiment, an exemplary heating process may be performed under an inert gas, such as nitrogen or argon at room pressure. In an exemplary embodiment, after an exemplary heating process, an exemplary inorganic part of an exemplary paint sludge may remain in an exemplary furnace. In an exemplary embodiment, an exemplary organic part of an exemplary paint sludge may include at least one of acrylic resins, epoxy resins, alkyd resins, and organic solvents. Exemplary organic solvents may include at least one of aromatic hydrocarbons, alcohols, and esters, such as tetralin, xylene, butanol, butyl glycol, butyl acetate, butyl glycolate, and butyl diglycol acetate. In an exemplary embodiment, an exemplary inorganic part of an exemplary paint sludge is referred to herein as an exemplary first mixture. In an exemplary embodiment, an exemplary first mixture may include at least one of silicon dioxide, aluminum oxide, iron oxide, calcium oxide, titanium dioxide, magnesium oxide, sodium oxide, and potassium oxide.

In an exemplary embodiment, step 104 of precipitating the second mixture in the first mixture may include mixing an exemplary first mixture with a sodium hydroxide solution in a mechanical mixer. In an exemplary embodiment, an exemplary mechanical mixer may include a container and rotating wings inside an exemplary container. In an exemplary embodiment, exemplary rotating wings may homogeneously mix an exemplary first mixture and an exemplary sodium hydroxide solution with a rotational speed of exemplary rotating wings in a range of 50 rpm to 400 rpm for 2 hours to 10 hours. In an exemplary embodiment, an exemplary first mixture and an exemplary sodium hydroxide solution with a concentration of an exemplary sodium hydroxide solution in a range of 1 mol/L to 6 mol/L may be heated at a temperature in a range of 25° C. to 90° C. to dissolve aluminum oxide and silicon dioxide in an exemplary sodium hydroxide solution. In an exemplary embodiment, an exemplary second mixture may precipitate in an exemplary mechanical mixer because an exemplary sodium hydroxide solution may not be able to dissolve an exemplary second mixture. In an exemplary embodiment, an exemplary second mixture may include at least one of iron oxide, calcium oxide, titanium dioxide, magnesium oxide, sodium oxide, and potassium oxide. In an exemplary embodiment, an exemplary second mixture may be separated from an exemplary aqueous phase by filtration utilizing for example, a filter paper or a filter press. In an exemplary embodiment, an exemplary sodium hydroxide solution may be mixed with an exemplary first mixture in an exemplary mechanical mixer with a weight ratio in a range of 1:5 to 1:15 (first mixture:sodium hydroxide solution).

In an exemplary embodiment, step 104 of precipitating the second mixture in the first mixture may further include separating aluminum oxide from an exemplary first mixture. In an exemplary embodiment, an exemplary sodium hydroxide solution may dissolve silicon dioxide and aluminum oxide and an exemplary second mixture may sediment. After an exemplary filtration of an exemplary second mixture, an exemplary supernatant of an exemplary mixture may be used to recover aluminum oxide. To this end, CO₂ may be injected into an exemplary solution of aluminum oxide and silicon dioxide for 1 to 4 hours. In an exemplary embodiment, injecting CO₂ into an exemplary solution may decrease the pH of an exemplary supernatant and may adjust an exemplary pH in a range of 7 to 12. Specifically, CO₂ may be injected until a pH of an exemplary supernatant is in a range of 7 to 12. In an exemplary embodiment, decreasing an exemplary pH may force an exemplary aluminum hydroxide powder to precipitate. An exemplary aluminum hydroxide powder may be filtered utilizing for example, a filter paper or a filter press. In an exemplary embodiment, an exemplary aluminum hydroxide powder may be heated at a temperature in a range of 1000° C. to 1200° C. for 1 and 3 hours in a furnace to remove hydrogen atoms from an exemplary molecular structure of aluminum hydroxide and produce aluminum oxide.

In an exemplary embodiment, step 106 of recovering titanium dioxide from the second mixture may include mixing an exemplary second mixture with an exemplary hydrochloric acid solution in a mechanical mixer. In an exemplary embodiment, exemplary rotating wings may homogeneously mix an exemplary second mixture and an exemplary hydrochloric acid solution with a rotational speed of exemplary rotating wings in a range of 50 rpm to 400 rpm for 1 to 6 hours. In an exemplary embodiment, an exemplary second mixture and an exemplary hydrochloric acid solution may be heated at a temperature in a range of 25° C. to 90° C. due to the better solubility of iron oxide at higher temperatures. In an exemplary embodiment, an exemplary hydrochloric acid solution with a concentration of in a range of 1 mol/L to 4 mol/L may dissolve iron oxide, calcium oxide, magnesium oxide, sodium oxide, and potassium oxide of an exemplary second mixture. In an exemplary embodiment, a titanium dioxide powder may precipitate in an exemplary mechanical mixer because an exemplary hydrochloric acid solution may not be able to dissolve titanium dioxide. In an exemplary embodiment, an exemplary titanium dioxide powder may be separated from an exemplary aqueous phase by filtration utilizing, for example, a filter paper or a filter press. In an exemplary embodiment, an exemplary hydrochloric acid solution may be mixed with an exemplary second mixture in an exemplary mechanical mixer with a weight ratio in a range of 1:5 to 1:15 (second mixture:hydrochloric acid solution). In an exemplary embodiment, an exemplary titanium dioxide powder may be heated in an oven at a temperature in a range of 80° C. to 90° C. for 3 hours to 4 hours to form a dry-white powder of titanium dioxide. An exemplary dry-white powder of titanium dioxide may have a purity more than 99%. As used herein, 99% purity may indicate that for example, in 100 g of an exemplary dry-white powder of titanium dioxide there may be more than 99 g pure titanium dioxide and less than 1 g impurity.

### Example 1: Pyrolysis of a Paint Sludge

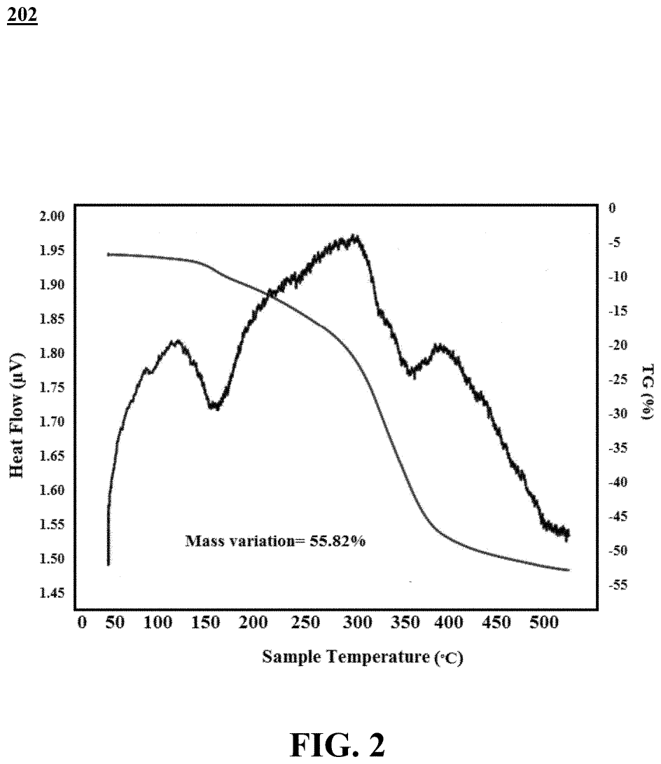

In this example, a method similar to method 100 may be used to produce the first mixture. To this end, an organic part of the paint sludge may be separated by heating the paint sludge at 600° C. FIG. 2 shows thermogravimetric analysis (TGA) pattern 202 of the paint sludge, consistent with one or more exemplary embodiments of the present disclosure. In a temperature range of in a range of 170° C.-180° C., 55.82 wt. % of the total weight of the paint sludge may be decreased. At a higher temperature of 340° C.-350° C., 10.45 wt. % of the total weight of the paint sludge and at a temperature of 440° C.-450° C., 1.55 wt. % of the total weight of the paint sludge may be lost which may be due to the evaporation of the organic part of the paint sludge. The inorganic part may be resistant to the temperature of 500° C., which may indicate that 68 wt. % loss of the total weight of the paint sludge may be due to the evaporation of the organic part. The process of heating may be performed in a pyrolysis furnace under nitrogen atmosphere. TGA pattern 202 may show that 10 wt. % of the total weight of the paint sludge may decrease after 10 minutes and the heating process should be extended for a longer time duration.

Table 1 shows results of the X-ray fluorescence (XRF) analysis of a paint sludge, consistent with one or more exemplary embodiments of the present disclosure. Table 1 shows a weight percent of loss on ignition (LOI) in an exemplary paint sludge. As used herein, LOI may refer to the mass of moisture and volatile materials present in an exemplary paint sludge.

TABLE 1

| | Composition | | | | | | | | |
|---|---|---|---|---|---|---|---|---|---|
| | SiO₂ | Al₂O₃ | Fe₂O₃ | CaO | TiO₂ | MgO | Na₂O | K₂O | LOI |
| wt. % | 1.66 | 7.77 | 0.84 | 0.95 | 17.61 | 0.44 | 0.17 | 0.02 | 71 |

Table 1 shows weight percentages of the constituents of a paint sludge which may indicate that there may be about 20 wt. % titanium dioxide and 8 wt. % aluminum oxide in the paint sludge. More than 50 wt. % of the paint sludge may include an organic part, such as resins and solvents.

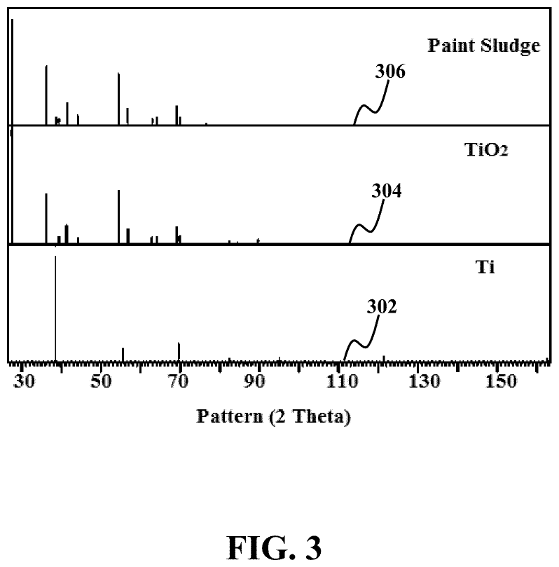

FIG. 3 shows X-ray diffraction (XRD) patterns of titanium, titanium dioxide, and the paint sludge before applying a heating process, consistent with one or more exemplary embodiments of the present disclosure. XRD pattern 302, 304, and 306 show titanium, titanium dioxide, and the paint sludge characteristic peaks. XRD pattern 306 may show the presence of rutile phase of titanium dioxide in the paint sludge.

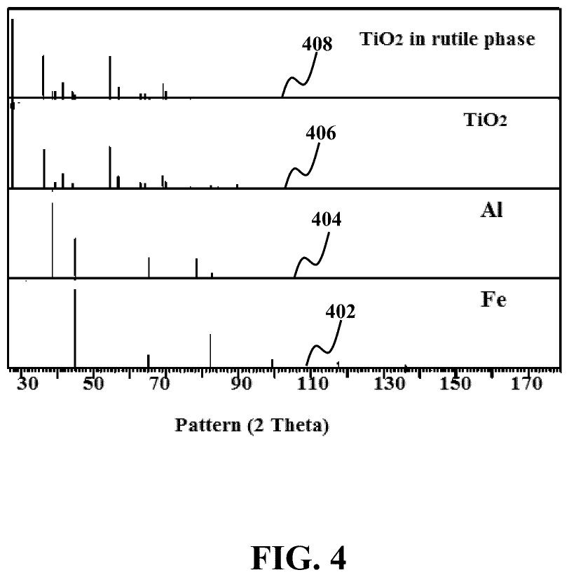

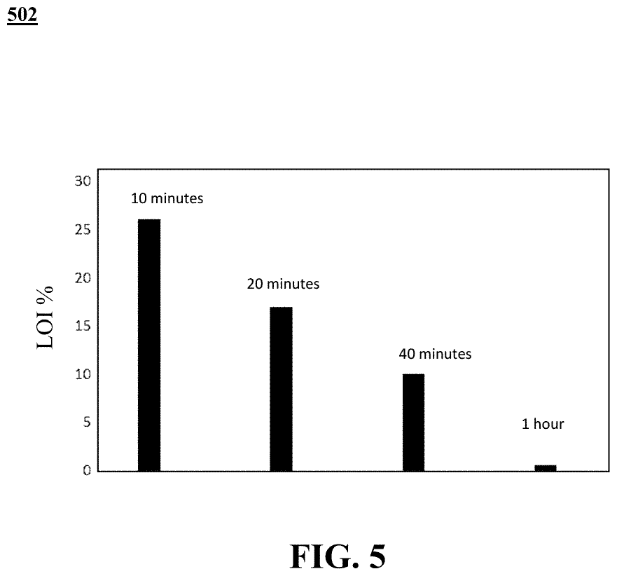

FIG. 4 shows X-ray diffraction (XRD) patterns of iron, aluminum, titanium dioxide, and the paint sludge after applying the heating process, consistent with one or more exemplary embodiments of the present disclosure. The heating process may be performed at a temperature of 500° C. for 10 minutes. XRD pattern 408 may show detectable titanium dioxide in rutile phase, which may indicate that the heating process may have no influence on changing the titanium dioxide phase. XRD patterns 402, 404, and 406 show characteristic peaks of Fe, Al, and TiO₂, respectively. The heating process may be tested for the duration of 10 minutes, 20 minutes, 40 minutes, and 1 hour. FIG. 5 shows X-ray fluorescence (XRF) data of the paint sludge, consistent with one or more exemplary embodiments of the present disclosure. XRF image 502 may indicate that the weight percent of the organic part of the paint sludge may decrease below 2 wt. % after 1 hour of the heating process.

Table 2 shows XRF data of the paint sludge after the heating process, consistent with one or more exemplary embodiments of the present disclosure.

TABLE 2

| | Composition | | | | | | | | | |
|---|---|---|---|---|---|---|---|---|---|---|
| | SiO₂ | Al₂O₃ | Fe₂O₃ | CaO | TiO₂ | MgO | Na₂O | K₂O | MnO | LOI |
| wt. | 3.01 | 21.62 | 1.5 | 1.95 | 46.5 | 0.68 | 0.35 | 0.048 | 0.012 | 23.5 |
| % | | | | | | | | | | |

Table 2 may show that the organic part of the paint sludge may be decreased after the heating process. Titanium dioxide and aluminum oxide may be the two most abundant parts in the paint sludge.

### Example 2: A Hydrometallurgical Process for Recovering TiO₂ from a Paint Sludge

In this example, a method similar to method 100 may be used to separate TiO₂ from a paint sludge. To this end, after the heating process, the organic part of the paint sludge may be removed in the form of gas and liquid. The remaining of the heating process may be TiO₂, aluminum oxide, iron oxide, silica, calcium oxide, and manganese oxide.

Two solutions of sodium hydroxide with concentrations of 2 mol/L and 4 mol/L may be mixed with the first mixture remained from the heating process. The mixing may be performed at a temperature in a range of 80° C. to 90° C. The sediment may be washed with water to neutralize pH and remove dissolved ions. After washing the sediment, hydrochloric acid solution with a concentration of 2 mol/L and 4 mol/L may be used to remove iron oxide. Table 3 shows parameters of the two leaching processes.

TABLE 3

| Number | Parameters | Amounts |
|---|---|---|
| 1 | Sodium hydroxide concentration | 2-4 mol/L |
| 2 | Hydrochloric acid concentration | 2-4 mol/L |
| 3 | Weight ratio of the solid to liquid | 1:10 (solid: |
| | | liquid) |
| 4 | Temperature for the first leaching process | 80° C.-90° C. |
| | (NaOH solution) | |
| 5 | Rotational speed of the mechanical mixer | 400 rpm |
| 6 | Time of the first leaching process | 4-8 hours |
| 7 | Temperature for the second leaching | 85° C. |
| | process (HCl solution) | |
| 8 | Time of the second leaching process | 2-4 hours |

The optimum parameters of the three steps of pyrolysis, leaching with sodium hydroxide solution, and leaching with hydrochloric acid solution are shown in Table 4.

TABLE 4

| Number | Parameters | Amounts |
|---|---|---|
| 1 | Heating temperature | 500° C. |
| 2 | Time of the heating process | 1 hour |
| 3 | Concentration of the sodium hydroxide solution | 4 mol/L |
| 4 | Concentration of the hydrochloric acid solution | 2 mol/L |
| 5 | Weight ratio of the solid to liquid | 1:10 (solid: |
| | | liquid) |
| 6 | Time of the first leaching process | 85° C. |
| 7 | Rotational speed of the mechanical mixer | 400 rpm |
| 8 | Time of the first leaching process | 8 hours |
| 9 | Temperature for the second leaching process | 85° C. |
| | (HCl solution) | |
| 10 | Time of the second leaching process | 4 hours |

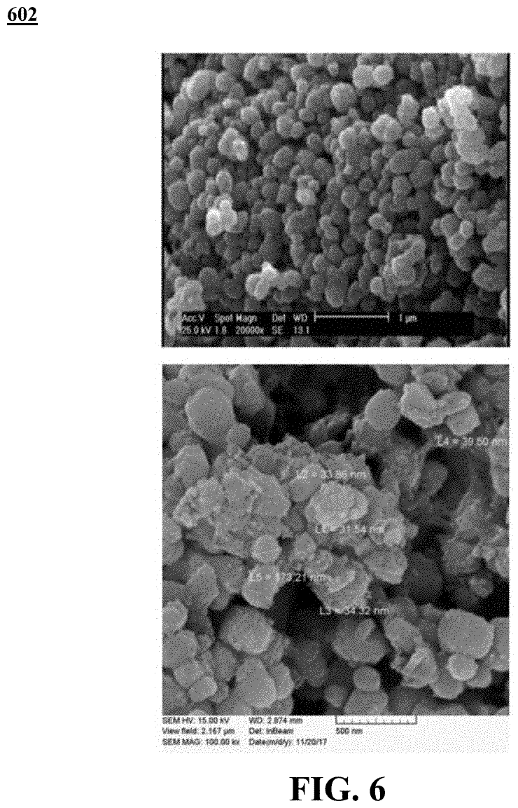

FIG. 6 shows field emission scanning electron microscopy (FE-SEM) images of titanium dioxide after the leaching processes, consistent with one or more exemplary embodiments of the present disclosure. FE-SEM image 602 may show that after the two-step leaching process, the size of the TiO₂ particles may be below 1 μm.

### Example 3: Recovering Aluminum Oxide from a Paint Sludge

In this example, a method similar to method 100 may be used to separate aluminum oxide from a paint sludge. After alkaline leaching using NaOH solution, the solution and the sediment may be separated by filtration. To separate aluminum oxide from the solution, CO₂ may be injected into the solution and may change the pH from 14 to 7. The white powder of aluminum hydroxide may be settled inside the solution. The sediment of this step (Al(OH)₃) may be separated by filtration. The aluminum hydroxide powder may be heated at 1100° C. for 1 hour in a furnace to produce aluminum oxide. To remove hydrogen atoms from inside the crystals of aluminum oxide, the heating rate may be adjusted at 10° C. per minute.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A method for recovering metal oxides from a paint sludge, the method comprising:
obtaining a first mixture by evaporating an organic part of the paint sludge by heating the paint sludge in a furnace at a temperature in a range from 350° C. to 600° C.;
precipitating a second mixture in the first mixture by mixing the first mixture and a sodium hydroxide solution with a weight ratio in a range from 1:5 to 1:15 (the first mixture:the sodium hydroxide solution);
obtaining a supernatant solution by separating the precipitated second mixture from the first mixture;
recovering titanium dioxide from the separated precipitated second mixture by mixing the separated precipitated second mixture with a hydrochloric acid solution with a weight ratio in a range from 1:5 to 1:15 (separated precipitated second mixture:hydrochloric acid solution);
precipitating aluminum hydroxide from the supernatant solution by injecting CO₂ into the supernatant solution; and
forming aluminum oxide by heating the precipitated aluminum hydroxide at a temperature in a range from 1000° C. to 1200° C.

2. A method for recovering metal oxides from a paint sludge, the method comprising:
obtaining a first mixture by evaporating an organic part of the paint sludge by heating the paint sludge in a furnace;
precipitating a second mixture from the first mixture by mixing the first mixture and a sodium hydroxide solution; and
recovering titanium dioxide from the second mixture by mixing the second mixture with a hydrochloric acid solution.

3. The method of claim 2, wherein heating the paint sludge in the furnace comprises heating the paint sludge at a temperature in a range from 350° C. to 600° C.

4. The method of claim 3, wherein heating the paint sludge in the furnace further comprises heating the paint sludge under an inert atmosphere, the inert atmosphere comprising at least one of a pure nitrogen atmosphere and a pure argon atmosphere.

5. The method of claim 4, wherein heating the paint sludge in the furnace further comprises heating the paint sludge for a period in a range from 20 minutes to 2 hours.

6. The method of claim 2, wherein mixing the first mixture and the sodium hydroxide solution comprises mixing the first mixture and a sodium hydroxide solution with a concentration in a range from 1 mol/L to 6 mol/L.

7. The method of claim 6, wherein precipitating the second mixture from the first mixture comprises mixing the first mixture and the sodium hydroxide solution with a weight ratio in a range from 1:5 to 1:15 (first mixture:sodium hydroxide solution).

8. The method of claim 7, wherein precipitating the second mixture from the first mixture comprises mixing the first mixture and the sodium hydroxide solution in a mechanical mixer with a stirrer speed in a range from 50 rpm to 400 rpm.

9. The method of claim 8, wherein precipitating the second mixture from the first mixture comprises mixing the first mixture and the sodium hydroxide solution in the mechanical mixer for a period in a range from 2 to 10 hours.

10. The method of claim 9, wherein precipitating the second mixture from the first mixture comprises mixing the first mixture and the sodium hydroxide solution in the mechanical mixer at a temperature in a range from 25° C. to 90° C.

11. The method of claim 2, wherein recovering titanium dioxide from the second mixture comprises mixing the second mixture with the hydrochloric acid solution with a weight ratio in a range from 1:5 to 1:15 (second mixture:hydrochloric acid solution).

12. The method of claim 11, wherein mixing the second mixture with the hydrochloric acid solution comprises mixing the second mixture with a hydrochloric acid solution with a concentration in a range from 1 mol/L to 4 mol/L.

13. The method of claim 12, wherein recovering titanium dioxide from the second mixture comprises mixing the second mixture with the hydrochloric acid solution in a mechanical mixer with a stirrer rate of 50 rpm to 400 rpm for 1 to 6 hours at 25° C. to 90° C.

14. The method of claim 2, wherein recovering titanium dioxide from the second mixture further comprises heating titanium dioxide at a temperature in a range of 80° C. to 90° C. for 3 to 4 hours.

15. The method of claim 2, wherein precipitating the second mixture from the first mixture further comprises obtaining a supernatant solution by filtering out the precipitated second mixture.

16. The method of claim 15, further comprising:
precipitating aluminum hydroxide from the supernatant solution by injecting CO₂ into the supernatant solution; and
forming aluminum oxide by heating the precipitated aluminum hydroxide.

17. The method of claim 16, wherein precipitating aluminum hydroxide from the supernatant solution comprises injecting CO₂ into the supernatant solution for 1 to 4 hours.

18. The method of claim 17, wherein precipitating aluminum hydroxide from the supernatant solution comprises adjusting pH of the supernatant solution in a range of 7 to 12 by injecting CO₂ into the supernatant solution.

19. The method of claim 16, wherein forming aluminum oxide comprises heating the precipitated aluminum hydroxide at a temperature in a range of 1000° C. to 1200° C.

20. The method of claim 19, wherein forming aluminum oxide comprises heating the precipitated aluminum hydroxide for 1 to 3 hours.
